(19) United States
(12) Patent Application Publication
(10) Pub. No.: US 2011/0051880 A1
(43) Pub. Date: Mar. 3, 2011

(54) High Efficiency Power Plants

(76) Inventors: Abdulsalam Al-Mayahi, Surrey (GB); Mohammed S. Aljohani, Jeddah (SA)

(21) Appl. No.: 12/790,823

(22) Filed: May 29, 2010

Related U.S. Application Data
(60) Provisional application No. 61/237,681, filed on Aug. 28, 2009.

(30) Foreign Application Priority Data
May 29, 2009 (GB) 0909242.0

(51) Int. Cl. G21C 15/24

(52) U.S. Cl. 376/370

(57) ABSTRACT

Modified Kalina and modified Mayahi cycle heat engines are disclosed. Improvements in efficiency may be gained through various changes to these cycles as well as combining these cycles with boiling water reactors and other Rankine cycle power plants.

### CROSS-REFERENCE TO RELATED APPLICATIONS

The present application claims priority to UK Patent App. No. GB0909242.0, titled “Boiling Water Reactor” and filed May 29, 2009 by Abdulsalam Al-Mayahi and Mohammed Aljohani. The present application also claims priority to U.S. Provisional App. No. 61/237,681, titled “Combined Cycle Power Plant” and filed Aug. 28, 2009 by Mohammed S. Aljohani, P. M. V. Subbarao, Abdulsalam Al-Mayahi and R. Senthil Murugan. The referenced priority applications are hereby incorporated herein by reference in their entirety.

### BACKGROUND

In a Rankine cycle operating in a condensing mode, a major portion of the heat in the cycle is rejected to the cooling water, which results in thermal pollution of the environment and a higher energy loss. In a multi-stage condensing turbine the last few stages of the turbine operate in a two phase region at low temperature leading to inefficient energy transfer in the low pressure (LP) turbine. When the condenser is working at vacuum pressure, air removal is mandatory; otherwise, the partial pressure of air increases the total pressure of the system and leads to a loss in power output and corrosion to various components. Due to a substantial increase in specific volume as the steam expands in the last few stages of a turbine, the size of the openings through which the steam passes must increase from stage to stage. Because of high volumetric flow rates, special care is needed for the appropriate choice of the LP turbine exhaust area and design.

A classic example of a power plant operating using the Rankine cycle is a boiling water reactor (BWR). A BWR is a nuclear reactor of light water developed by the General Electric Company in the mid 1950s, in which the normal very pure water is considered as a coolant and as a moderator for the reactor, water is boiling in the core of the reactor and producing steam. In BWR, the water which moves upward through the reactor core absorbs heat and acts as both moderator and coolant. Some of liquid water is converted to a steam. The steam-water mixture leaves the top of the core and enters a moisture separator where water droplets are removed before the steam is allowed to enter the steam line, and the steam line directs the steam to the main turbine, causing it to rotate the turbine generator, which generates electricity. The exhausted steam from turbine enters the condenser where it is condensed into water. The condensed water is pumped out of the condenser with a series of pumps, reheated and pumped back to the reactor.

A standard operating pressure for these boiling water reactors is about 70 bar at which pressure the water boils at about 285 degree Celsius. This operating temperature gives a Carnot efficiency of only 42% with a practical operating efficiency of around 32%, somewhat less than a pressurized water reactor (PWR), a nuclear reactor operated at higher pressure so the water (the working fluid) does not change state to water vapor.

The BWR is characterized by the two-phase flow (water and steam) in the top part of the reactor core. Light water as a working fluid converys heat away from the nuclear fuel. The liquid water in the region of the fuel elements also “thermalizes” neutrons, i.e., trims down their kinetic energy, which is needed to recover the probability of fission of fissile fuel. Fissile fuel material, such as the U-235 and Pu-239 isotopes, have large capture cross sections for thermal neutrons.

Feedwater enters reactor pressure vessel (RPV) inside the BWR through nozzles high on the vessel, well above the upper part of the nuclear fuel assemblies (these nuclear fuel assemblies constitute the “core”) but lower the water level. The feedwater is pumped into the RPV from the condensers located under the low pressure turbines and after going through feedwater heaters that raise its temperature with extraction steam from various turbine stages.

The feedwater enters into the downcomer section and combines with water coming down from the water separators. The feedwater subcools the saturated water that is recycled from the steam separators. The water is separated from the core by a tall shroud and flows down the downcomer section, which then goes through either jet pumps or internal recirculation pumps that provide additional pumping power (hydraulic head). The water now turns and moves up through the lower core plate into the nuclear core where the fuel elements heat the water. When the flow shifts out of the core through the upper core plate, about 12 to 15% of the flow by volume is saturated steam.

By heating, the core can generate a thermal head that assists the recirculation pumps in recirculating the water inside of the RPV. Without recirculation pumps a BWR can be designed and relies entirely on the thermal head to recirculate the water inside of the RPV. The forced recirculation head from the recirculation pumps is very useful in controlling power that is simply varied by increasing or decreasing the speed of the recirculation pumps.

The two phase fluid under saturation (water and steam) above the core enters the riser area which is at the top part of tall shroud where water separator is. The height of this section could be increased to enlarge the thermal natural recirculation pumping head. By spinning the two phase flow in cyclone separators, the steam is separated and goes up towards the steam dryer while the water remains behind and flows horizontally out into the downcomer region. In the downcomer region, it merges with the feedwater flow and the cycle repeats.

Reactor power is controlled by means of two methods, either by inserting or withdrawing control rods and/or by changing the water flow through the reactor core.

In all BWRs the ratio of the saturated liquid water to the saturated steam out from the separator is very high and lays on between 10-25 times, depends on the design features of the nuclear reactor and operating conditions. Accordingly, the high amount of saturated liquid within the reactor could be considered as an additional heat source if its sensible heat is taken and well utilized via proper process and apparatus such as running a power plant with high efficiency.

The Rankine cycle is the basic heating engine operating cycle used by most steam engines since the start of the industrial age, using heat sources starting with burning wood, oils, and gases, all the way to nuclear fission and fusion and beyond. Any heat source may be used. As with most heat engine cycles, the Rankine cycle is basically a four-stage process. Simply put, the working fluid (usually water) is pumped into a boiler. While the fluid is in the boiler, an external heat source heats the fluid, preferably superheats. The hot water vapor then expands to drive a turbine. Once past the turbine, the steam is condensed back into liquid and recycled back to the pump to start the cycle all over again. Pump, boiler, turbine and condenser are the four parts of a standard steam engine and represent each phase of the Rankine cycle.

The organic Rankine cycle (ORC) is a non-superheating thermodynamic cycle that uses an organic working fluid to generate electricity. The working fluid is heated to boiling, and the expanding vapor is used to drive a turbine. This turbine can be used to drive a generator to convert the work into electricity. The working-fluid vapor is condensed back into liquid and fed back through the system to do the work again. The organic chemicals used by an ORC include Freon and most of the other traditional refrigerants such as iso-pentane, CFCs, HFCs, butane, propane and ammonia.

Today, ORC systems are being evaluated to improve the working efficiency of distributed generation systems, to generate electricity from geothermal or solar natural heat sources, or to recover waste heat from industrial processes.

FIG. 1 illustrates the main parts of the BWR 100 or any basic power plant using the Rankine cycle. The BWR is a power plant or a heat engine for converting the thermal nuclear energy to mechanical power then generating electricity. The BWR uses a light normal water as a working fluid within a closed cycle. The nuclear reactor works as a source of steam (boiler 10) whereas the other three parts: turbine 30, condenser 40, and pump 50 are similar to those existing in any conventional Rankine cycle.

Referring to FIG. 1 in detail, steam and water are transferred from the lower part of a reactor core 10 to the upper part (a separator) 20 via line 11. From the separator 20 the substantially dry steam in line 21 enters the turbine 30 to generate electrical power in generator 32. The saturated liquid water leaves the separator 20 via line 22 and is mixed with condensed water coming from the condenser 40. The steam at low pressure and temperature leaves the turbine 30 via line 31 and enters the condenser 40, which is continuously cooled through cold stream 41. Cold stream 41 could be any source of convenient coolant such as cooling tower water, seawater, river water, or dry air, etc., which leaves the condenser 40 at a higher temperature via line 42. The condensate water leaves the condenser 40 via line 43 and is pumped by high pressure pump 50, leaving the pump via line 51 to be merged with the saturated liquid water in line 22. The mixed water of lines 51 and 22 is normally sub-cooled and enters the reactor core 10 via line 12.

Kalina proposed a novel bottoming cycle for use in conventional steam and gas combined cycle systems. The Kalina cycle is a modified Rankine cycle, or rather a reversed absorption cycle utilizing ammonia-water working fluid and patented by Exergy Inc and A. Kalina. All Kalina cycles employ as working fluid a mixture of at least two working fluids, generally, though not exclusively, water and ammonia. Various published works describe advantages of the ammonia-water mixture for power generation using low grade heat. The multi-component working fluid, having a variable boiling temperature, generates less energy loss in the evaporator as the waste heat source has variable temperature in the evaporator as well. The ratio between those components is varied in different parts of the system to increase thermodynamic reversibility and therefore increase thermodynamic efficiency. There are multiple variants of Kalina cycle systems specifically applicable for different types of heat sources.

The Kalina cycle has proved theoretically and practically to have higher efficiency than other Rankine cycles such as organic Rankine cycle (ORC) but at the same time there are inherent limitations and higher initial costs.

The ammonia-water mixture used as the working fluid in the Kalina cycle has both varying boiling and condensing temperatures. Because of the variable boiling temperature, the temperature rise of the ammonia-water mixture, in a counter-flow heat exchanger, more closely follows the straight line temperature drop of a sensible heat source. The thermo-physical properties of the ammonia-water mixture can be altered by changing the ammonia concentration. Ammonia-water has thermo-physical properties that cause mixed fluid temperatures to increase or decrease without a change in the heat content.

In a typical Kalina cycle, a pressure-reducing valve (or throttle valve) is used to reduce the pressure of the lean liquid stream to a lower pressure downstream of the turbine. Then, the richer ammonia liquid solution downstream should be pumped back to the evaporator. The

There are numerous prior patents relating to variations of the Kalina cycle, including U.S. Pat. No. 4,346,561, U.S. Pat. No. 4,489,563, U.S. Pat. No. 4,548,043, U.S. Pat. No. 4,586,340, U.S. Pat. No. 4,732,005, U.S. Pat. No. 4,763,480, U.S. Pat. No. 4,899,545, U.S. Pat. No. 5,029,444, U.S. Pat. No. 5,095,708, U.S. Pat. No. 5,822,990, U.S. Pat. No. 5,950,433, U.S. Pat. No. 6,735,948, U.S. Pat. No. 6,769,256, U.S. Pat. No. 6,820,421, U.S. Pat. No. 6,829,895, U.S. Pat. No. 6,910,334, U.S. Pat. No. 6,923,000, U.S. Pat. No. 6,941,757 and U.S. Pat. No. 6,968,690.

FIG. 2 shows a simplified schematic for a conventional Kalina Cycle. The mixed working fluid, which in a water-ammonia system has a boiling point dependent on concentration, passes as a mixture of water and vapor from an evaporator 210 through line 213 to be partially separated in a separator stage 220. The richer vapor component 221 passes to a turbine 230 for generation of electricity, while the leaner liquid component 222 passes via a recuperator heat exchanger 240 into line 241 and through a throttle valve 280, which reduces its pressure, to rejoin the richer stream 245 downstream of the turbine 230.

The recuperator 240 provides heat exchange with the condensate vapor and liquid stream 251, which is first formed in the condenser 260, pumped via high pressure pump 270, and heated through heat exchanger 250. The rejoined leaner and richer streams 245 pass through the heat exchanger 250 and from line 255 into a condenser 260, where vapors condense to liquid in heat exchange with a cold stream 262 from cooling tower 263, entering the cooling tower through line 264 and then sprayed into the cooling tower 263. The liquid working fluid is pumped back to the evaporator 210 by the high pressure pump 270 pulling from line 264 into line 271. Entering the evaporator 210 through line 242, the working fluid at the evaporator 210 is evaporated by heat exchange with a heating source working fluid flowing from line 212 into evaporator 210 and then out line 211.

The Mayahi cycle also uses ammonia-water as an organic working fluid, which is similar to the Rankine cycle but with a higher efficiency. International patent publication No WO/2009/037515 with publication date Mar. 26, 2009, relates to the Mayahi cycle.

Referring to FIG. 3 of the Mayahi cycle 300, the working fluid mixture in an evaporator 310 is heated by a heat source working fluid via line 312 and then leaves the evaporator 310 at lower temperature via line 313. Ammonia vapor is produced under pressure from an aqueous solution of ammonia within the evaporator 310. The pressurized gas in line 314 drives a turbine 320 to produce electricity from a generator 322 coupled to the turbine. Ammonia gas at reduced pressure passes to absorber/condenser 330 in line 321. The heat is rejected from condenser 330 through cooling stream 332, which leaves at higher temperature via line 333.

The key to the Mayahi cycle is the way in which the concentration of, and amounts of, ammonia solution in the condenser 330 and evaporator 310 are maintained. This is achieved in the power generation system of FIG. 3 by a first flow of solution from the higher pressure evaporator 310 to the condenser 330, and by a second flow of solution from the condenser 330 to the evaporator 310 with aid of an auxiliary pump 340. The solutions in the first and second flows are “exposed” to each other in two different apparatus, namely an energy recovery device (ERD), such as energy recovery turbine (ERT) 350 and a heat exchanger 360. In the ERT 350, an apparatus commonly employed in reverse osmosis desalination plants, the high pressure of one liquid is transferred to another. Here the high pressure of the flow from the evaporator 310 in line 362 is transferred to the lower pressure flow from the condenser 330 in line 341, the lowered pressure flow from the evaporator 310 in line 352 passing to the condenser 330 in this example being employed for the spray via line 352. Because the low pressure of the condenser flow has already been increased by pressure exchange in the ERT 350, the pump 340 serves only an auxiliary purpose to increase the pressure of the stream in line 331 to higher pressure in line 351, and so does not need to be a high pressure pump. Heat exchanger 360 exchanges heat between the evaporator flow 314 and the increased pressure flow from the condenser 351 before that flow enters the evaporator via line 361.

Systems and methods for converting the thermal energy of low grade energy sources (low temperature heat sources) into electric power present a significant area of potential power generation. There is a necessity for a method and apparatus for increasing the efficiency of the conversion of such low temperature heat to electric power that improves the efficiency of the standard Rankine cycles, the Kalina cycle, or Mayahi cycle.

The present disclosure will include the existence of equivalent variations of specific embodiments, methods, and examples described herein. The present disclosure should therefore not be limited by the below described embodiments, methods, and examples, but by all embodiments and methods within the scope of the appended claims.

### BRIEF DESCRIPTION OF THE DRAWINGS

The invention is hereinafter more particularly described by way of example only with reference to the accompanying drawings, in which:

FIG. 1 is a simplified schematic diagram of a conventional boiling water reactor or other Rankine cycle power plant.

FIG. 2 is a schematic diagram of the Kalina cycle.

FIG. 3 is a schematic diagram of the Mayahi cycle.

FIG. 4 is a similar diagram to FIG. 2 showing a modified Mayahi cycle in accordance with various embodiments of the present invention.

FIG. 5 is a similar diagram to FIG. 3 showing a modified Kalina cycle in accordance with various embodiments of the present invention.

FIG. 6 shows the better performance of combined Rankine-Kalina cycle over the conventional Rankine cycle.

### DETAILED DESCRIPTION

Embodiments of the present invention present methods and systems that may be used and combined with a conventional power plant or a BWR to extract more power at higher efficiency in comparison with conventional power plants.

One embodiment of the present invention presents methods and systems that may be used and combined with a conventional power plant or a BWR to extract the sensible heat from the saturated water coming out from the separator inside the heat source or reactor core.

One embodiment of the present invention presents methods and systems that may be used to extract the sensible heat of a conventional power plant or a BWR through an ammonia-water cycle, such as conventional Kalina cycle, to generate electrical power at a high efficiency.

One embodiment of the present invention presents methods and systems that may be used to extract the sensible heat of a conventional power plant or a BWR through a modified Kalina cycle to generate electrical power at high efficiency in comparison with the conventional Kalina cycles.

One embodiment of the present invention presents methods and systems that may be used to extract the sensible heat of a conventional power plant or a BWR where thermal heat out in a sensible heat form is used as a heating source for the boiler of the conventional Mayahi cycle.

One embodiment of the present invention presents methods and systems that may be used to extract the sensible heat of a conventional power plant or a BWR where thermal heat out in a sensible heat form is used as a heating source for the boiler of a modified Mayahi cycle.

In prior art Kalina systems a pressure-reducing valve or throttle valve is essential to reduce the pressure of the lean liquid stream to the low pressure at the downstream side of the turbine. In addition, the condensed liquid working fluid from the condenser is pumped back to the evaporator.

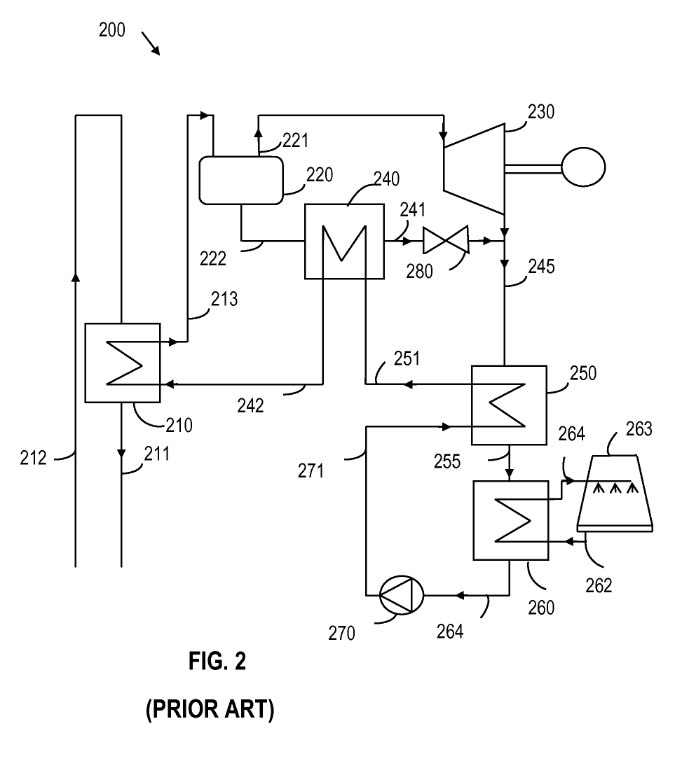

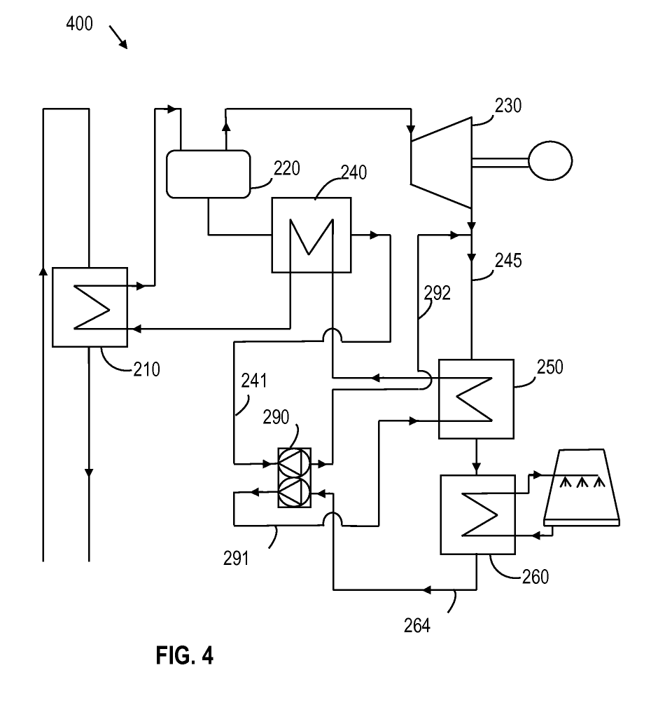

In FIG. 4, like reference numerals are employed to those of FIG. 2. It will be noted that the throttle valve is omitted. Instead the high pressure lean liquid from the recuperator transfers its high pressure to the return liquid stream from the condenser to the evaporator by passing through an energy recovery turbine ERT before, with reduced pressure, rejoining the richer stream leaving the turbine. Because the pressure of the return stream has been raised as a result of this pressure transfer, only a small auxiliary pump may be required instead of the main high pressure pump.

A hydraulic Turbo Charger (Energy Recovery Turbine) is an energy exchanger for transferring hydraulic energy between two liquid streams, wherein one stream is at a comparatively higher pressure than the other, comprising a suitable related centrifugal mechanism. An example where an Energy Recovery Turbine (Turbo Charger) finds application is in the production of potable water using a reverse osmosis (RO) membrane process. In the RO process, a feed saline solution is pumped into a membrane unit at high pressure. The input saline solution is then divided by the membrane array into high concentration saline solution (brine) at high pressure and permeates water at low pressure. Whereas the high-pressure brine is no longer useful in this process as a fluid, the hydraulic or pressure energy that it contains is important. A hydraulic Energy Recovery Turbine is employed to recover the hydraulic energy (pressure energy) in the brine and transfer it to the feed saline solution. After transfer of the pressure energy in the brine flow, the brine is directed at low pressure to drain. For example, Fluid Equipment Development Company FEDCO and Pump Engineering Inc (PEI) are both producing those Energy Recovery Turbines and Turbo Chargers. Today, thousands of energy recovery devices are used in the desalination plants around the world to save energy, especially with seawater RO plants.

Thus it will be seen that, while, in the conventional Kalina cycle of FIG. 2, internal pressure energy from the system is lost by using a pressure-reducing valve and external energy must be supplied to the system to pump the liquid solution back to evaporator, the cycle of FIG. 4 recovers the pressure from the lean stream and applies it to aid in pumping liquid back to the evaporator.

The described improvement can be employed in any of the variations of the Kalina cycle disclosed in the various patents cited above, with similar energy recovery devices eliminating the need both for a throttle valve in the lean stream and a high-pressure liquid pump. This improvement will increase the overall Kalina efficiency and reliability by eliminating the liquid pump for the return flow or replacing the previous high-pressure pump with a low-pressure auxiliary pump, which may also reduce cost.

Mayahi Cycle (Engine) efficiency, like any heat engine, is limited by the Carnot efficiency. The theoretical Carnot efficiency value of a cycle is equal to the temperature difference in degrees Kelvin between the high temperature in the boiler and low temperature in the condenser divided by the high temperature value of the boiler in Kelvin. Practically, a Mayahi Engine could have a higher actual efficiency than previous engines due to the saving of the pumping energy for the condensate back to the boiler. Wasting this energy cannot be avoided in other real cycles such as the Kalina cycle.

Thus, in accordance with the Mayahi cycle, a hydraulic Energy Recovery Turbine together with a heat exchanger are used in conjunction for an ammonia-water heat engine (power plant) instead of the conventional pump that is commonly used to pump the working fluid from the condenser (absorber) to the boiler (evaporator). The advantage of using a heat exchanger in conjunction with a hydraulic Turbo Charger (Energy Recovery Turbine) is that it minimizes the heat losses through the mixing process between the contents of the boiler (evaporator) and the condenser (absorber). This Mayahi cycle can utilize any available energy sources for heating the evaporator (boiler) with a temperature range from 100° C. to 500° C. and most preferably with a temperature range from 100° C. to 300° C. Cooling the absorber can be achieved by any available cooling source with a preferable temperature range from minus 20° C. to 50° C. Preferably, any available cooling source such as seawater, river water, cooling towers and air cooling can be employed.

Ammonia concentration in the Mayahi Engine may be varied from 10 to 90% in the liquid phase and the preferred concentration depends on the temperatures of heating and cooling. Generally, higher concentrations of ammonia mean higher working pressure on both the boiler and the absorber according to the thermodynamic equilibrium between concentration, pressure, and temperature.

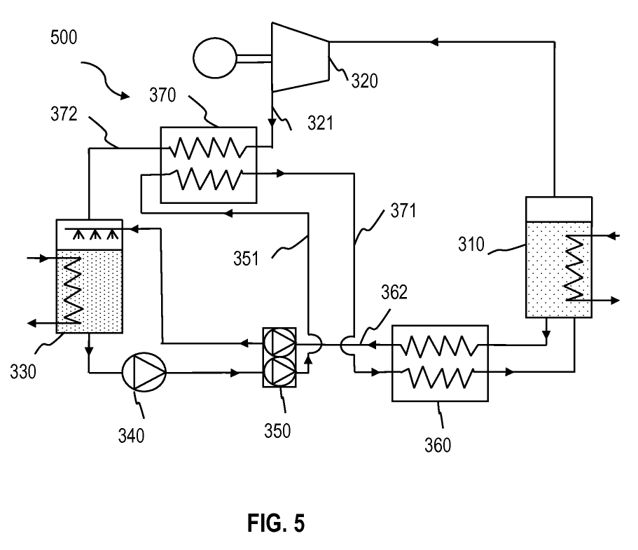

FIG. 5 presents such modification to the conventional Mayahi cycle by adding an extra recuperator (heat exchanger) to take the heat from ammonia vapor that leaves the turbine at relatively high temperature. The heat is recovered and brought back into the system with minimal loses. As a result, Mayahi cycle efficiency can be increased. Though it is not shown in FIG. 5, the modified Mayahi cycle may include a steam separator to separate low concentration ammonia liquid stream from the ammonia vapor outside the boiler.

Thus, in accordance with a first preferred embodiment of this aspect of the present invention, some of a sensible heat of the saturated water can be extracted from a BWR to run an ammonia-water cycle and generate power. Normally, BWR has a large amount of saturated water at a temperature of 285° C. and some of that sensible heat can be extracted. As a result of this invention, the BWR may operate at higher subcooling conditions that may require some fundamental modifications within the reactor core itself.

In a second preferred embodiment of this aspect of the present invention, the BWR could be redesigned and reengineered to allow for some of its saturated liquid at 285° C. coming down from the separator to leave the nuclear reactor cycle and operate an ammonia-water power plant.

In a third preferred embodiment of this aspect of the present invention, the BWR could be designed with new operating temperatures rather than the 285° C. to achieve maximum efficiency and optimum safe operating conditions. The new operating temperature could be ranged from 100-200° C., from 200-below 285° C., from above 285 to 300° C., and from 300 to 450° C.

In a fourth preferred embodiment of this aspect of the present invention, the ammonia water cycle is a conventional Kalina cycle based on the essence of the process in which the sensible heat from a BWR could be utilized to heat the boiler to make high pressure ammonia vapor which then can rotate the ammonia turbine and produce power.

In a fifth preferred embodiment of this aspect of the present invention, the Kalina cycle could be modified to enhance its efficiency by replacing the throttling valve with an energy recovery device. The modified Kalina cycle is not limited to be used with the BWR only however, as any power plant heat source could be used.

In a sixth preferred embodiment of invention, the modified Mayahi cycle could be combined with the BWR, utilizing the sensible heat to make the steam in the boiler and to rotate the turbine to generate power.

In a seventh preferred embodiment of this aspect of the present invention, the ammonia-water working fluid could replace the pure light water in the BWR and generate the ammonia vapor inside the BWR. In accordance with this embodiment, the BWR turbine will be used for ammonia and the nuclear reactor acts as a boiler in Mayahi or Kalina cycle.

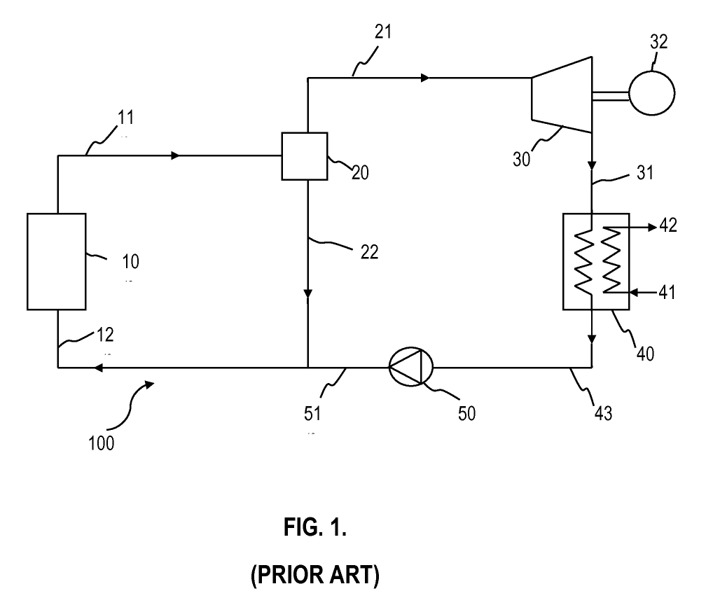

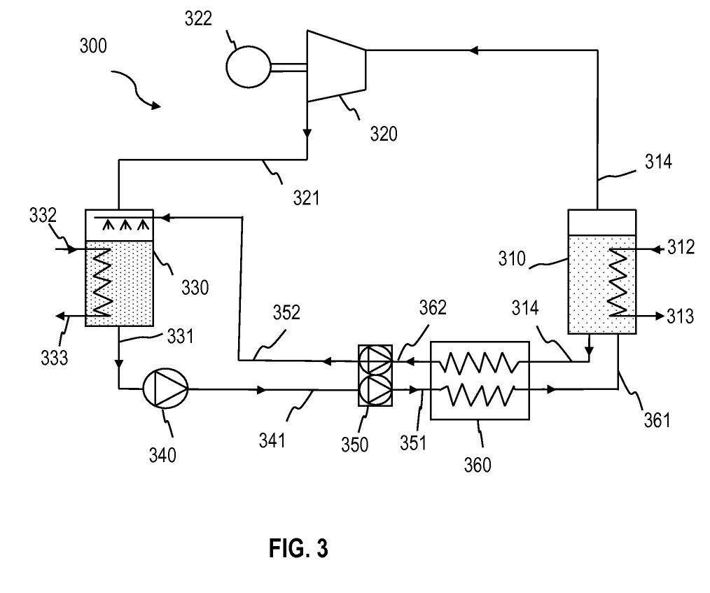

Note that a combined cycle is easily formed by having line 12 of FIG. 1 feed line 212 of FIG. 2 or line 312 for FIG. 3. The return line 211 of FIG. 2 or line 313 of FIG. 3 rejoins line 51 of FIG. 1 to form line 12 of FIG. 1.

An ammonia-water cycle may provide a higher power output and more efficiency when using low grade steam or saturated steam coming out from the Rankine cycle between temperatures of 80-350° C. This may include an increase in the boiler pressure in the Rankine cycle and expansion close to the atmospheric or above atmospheric pressure with a bottoming ammonia-water cycle (Kalina Cycle).

A combined cycle may mitigate energy loss occurring in different major parts of the Rankine cycle such as the condenser, the evaporator, and the steam turbine. This combined cycle is more efficient than the stand-alone Rankine cycle due to effective utilization of low grade steam in ammonia-water cycle for efficient power production. The important benefit of this cycle is higher boiler pressure in the topping part where water as a working fluid and higher condenser pressure in the bottoming part where ammonia-water mixture as a working fluid.

In one embodiment, an energy recovery turbine is used in the Kalina Cycle in place of the throttle valve and drives the high-pressure liquid pump. Thus, there may be no need to use throttle valves and no extra motor to drive the high pressure liquid pumps in the bottoming cycle. According to another embodiment of the present invention, the usage of an energy recovery turbine in Kalina Cycle will eliminate the usage of a high-pressure pump or replacing it with a small auxiliary pump and that may enhance the system reliability and reduce the cost.

Embodiments of the present invention may be used with all types of Kalina cycles known in the art and provide a modified Kalina Cycle as a better alternative as a bottoming cycle. Since the condenser (such as 260) may be operating above the atmospheric pressure, air leakage and energy losses are less than those in a simple Rankine cycle. Moreover deaeration is not required in the ammonia-water cycle due to high pressure condensation. This cycle is more suitable for a low grade steam at inlet pressure of 0.20 MPa to 1 MPa and its corresponding saturation temperature of 120° C.-180° C. than the Rankine cycle. An ammonia-water cycle is identified as a bottoming cycle for Rankine cycle power plant. The following are the major reason to select ammonia-water in the bottoming cycle.

1. Flexibility to reduce the fraction of ammonia in ammonia-water mixture helps to reduce heat transfer irreversibility in both evaporator and condenser when using low grade heat as a heat source for the bottoming cycle.

2. The fraction of ammonia in the ammonia-water mixture restricts vacuum operation in the condenser. To operate the condenser above atmospheric pressure reduces energy loss in the LP turbine and condenser and also it minimizes the need of deaeration.

3. Smaller turbine due to lower specific volume, higher efficiency due to less energy loss in the condenser.

Utilizing low grade steam below 0.20 MPa leads to vacuum operation in the heat exchanger. The heat source temperature to the bottoming cycle changes with time as output varies. Changing the composition in the Ammonia water mixture provides better optimum condition. The ability to change the mixture, and thus the thermodynamic properties of the working fluid offers an extra degree of control simply not possible in conventional Rankine power cycle.

Case Study for a Popular Steam Power Plant working on Regenerative Rankine Cycle:

Performance of stand-alone Rankine and combined cycle model is analyzed for design as well as off-design condition. An exclusive mathematical model and computer software is developed to optimize the performance and obtain best operational parameters of the combined cycle. Present model takes care of all the irreversibilities in the various part of the cycle and is more realistic analysis unlike many theoretical models.

A popular steam cycle design is used for present analysis. All the real parameters of existing popular steam power plant were used for the case study. FIG. 2 shows the variation of first law efficiency of popular steam power plant cycle as well as the new combined cycle configuration at different load condition. At design condition the cycle efficiency of combined cycle is 42.1989%.

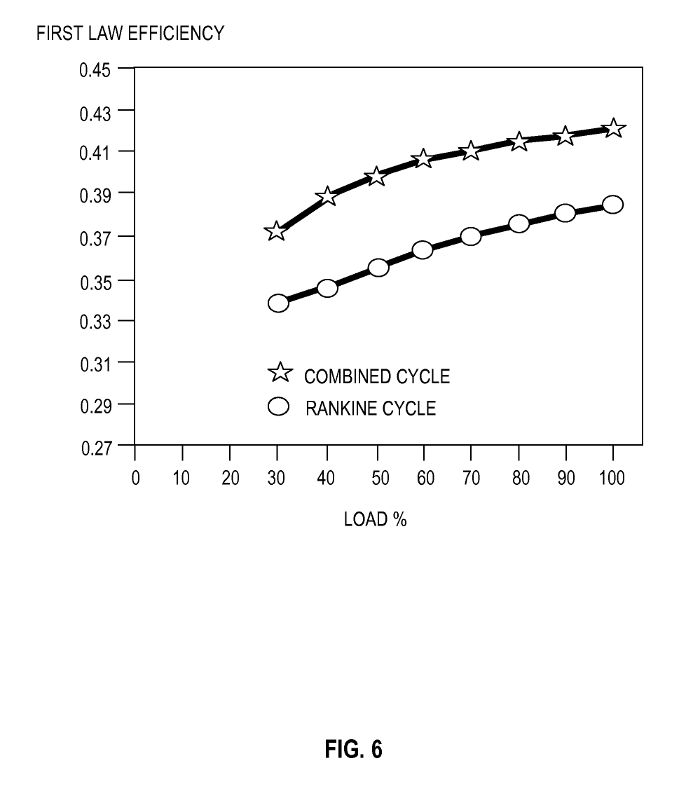

FIG. 6 shows the comparisons between variations of efficiency at different load condition of a simple Rankine cycle and the combined cycle

The parameters of the Cycle configuration for the present case study with the optimum operating conditions for combined cycle model are listed in Table 1.

TABLE 1
Results for combined cycle model

| | | | | | | S |
|---|---|---|---|---|---|---|
| Node | P (bar) | T ° C. | X₁ | h (kJ/kg) | M(kg/sec) | (kJ/kg K) |
| 1 | 194 | 361.5 | — | 1776.0 | 1 | 3.939 |
| 2 | 192 | 361.5 | — | 2465 | 1 | 5.023 |
| 3 | 190.0 | 540 | — | 3378.1 | 1 | 6.333 |
| 4 | 3.0 | 133.5 | — | 2563.7 | 0.77 | 6.595 |
| 5 | 3.0 | 133.5 | — | 561.5 | 0.77 | 1.672 |
| 6 | 3.00 | 133.5 | — | 590.1 | 1 | 1.742 |
| 7 | 195.9 | 142.8 | — | 613.6 | 1.0 | 1.748 |
| 8 | 195.9 | 159.4 | — | 684.2 | 1.0 | 1.915 |
| 9 | 195.9 | 262.7 | — | 1146.9 | 1.0 | 2.872 |
| 10 | 50.0 | 345.9 | — | 3058.3 | 0.20 | 6.434 |
| 11 | 6.900 | 164.4 | — | 2692.4 | 0.03 | 6.552 |
| 12 | 3.00 | 133.5 | — | 686.0 | 0.23 | 1.978 |
| 13 | 46.49 | 48.65 | 0.890 | 150.2 | 1.425 | 0.732 |
| 14 | 45.60 | 123.5 | 0.890 | 1233.0 | 1.425 | 3.678 |
| 15 | 45.60 | 123.5 | 0.9692 | 1456.8 | 1.1410 | 4.215 |
| 16 | 6.917 | 32.2 | 0.9692 | 1216.7 | 1.1410 | 4.302 |
| 17 | 45.60 | 123.5 | 0.5716 | 333.19 | 0.2839 | 1.5715 |
| 18 | 45.16 | 36.71 | 0.5716 | −64.62 | 0.2839 | 0.3864 |
| 19 | 6.917 | 37.66 | 0.5716 | −64.62 | 0.2839 | 0.4020 |
| 20 | 6.9171 | 36.71 | 0.890 | 961.44 | 1.425 | 3.527 |
| 21 | 6.6698 | 30.33 | 0.890 | 887 | 1.425 | 3.296 |
| 22 | 6.4876 | 15 | 0.890 | −9.9476 | 1.425 | 0.2270 |
| 23 | 4.7401 | 15.95 | 0.890 | −3.0085 | 1.425 | 0.2290 |
| 24 | 4.6945 | 31.74 | 0.890 | 0.955 | 1.425 | 0.4792 |
| 1c | 2 | 10 | — | 42 | 20.3 | 0.151 |
| 2c | 2 | 25 | — | 104.9 | 20.3 | 0.296 |

Results in Table.2 depict that combined cycle shows better performance than stand alone Rankine steam cycle. During design condition the bottoming cycle which utilizes low grade heat from the Rankine cycle is 2.1% more efficient than Rankine cycle for same heat input.

TABLE 2
Comparison of power output and efficiency
(for unit mass flow input of steam)

| | | | | Power | Power |
|---|---|---|---|---|---|
| First Law | First law | | | output | output |
| efficiency of | efficiency of | | | from | from |
| Stand alone | combined | First Law Efficiency | | Topping | bottoming |
| Rankine cycle | cycle | Topping | Bottoming | cycle | cycle |
| (%) | (%) | cycle | cycle | (kW) | (kW) |
| 38.42 | 42.19 | 0.3026 | 0.17119 | 675.2 | 264.13 |

Similarly First law efficiency of combined cycle is 4% more than Rankine cycle for same heat input. The results in table depicts that there is 20% less energy loss in the condenser of a combined cycle when compared to stand alone Rankine cycle. Due to less energy loss with same cooling water inlet and outlet temperature the cooling water flow rate of combined cycle is 21.09% lesser than the stand alone Rankine cycle.

TABLE 3
Comparison of condenser heat load and cooling water
flow rate (for unit mass flow input of steam)

| Condenser | Condenser | Cooling | Cooling |
|---|---|---|---|
| heat load | heat load | Water flow rate in the | Water flow rate In the |
| for stand alone | for combined | condenser of a stand alone | condenser of a combined |
| Rankine cycle (kW) | cycle (kW) | Rankine cycle (m³/hr) | cycle (m³/hr) |
| 1621 | 1287.8 | 1.5486 | 1.222 |

Energy loss in the condenser, irreversibility in the heat exchange process, especially in the evaporator, and efficiency losses due to expansion of low grade steam in the LP turbine are the three regions identified for performance loss in the Rankine cycle. The proposed combined cycle reduces these performance losses and improves the performance of the plant. Result shows that 4% improvement in cycle efficiency due to reduction of heat load in the boiler and 20% reduction of energy loss in the condenser and raise of 2.1% efficiency loss in the LP turbine. Consideration of the ammonia-water cycle as a bottoming cycle provides flexibility to raise the boiler pressure and to reduce energy loss in the condenser and ability to produce more power output using low grade steam.

### Example Embodiments

In a first embodiment, the lower pressure part of the Rankine cycle is completely replaced with Kalina Cycle at an optimal temperature point. This optimal point may vary between 100 C to 450 C, depending on the parameters of the main Rankine cycle. This embodiment is referred to as a Combined Rankine-Kalina Cycle.

In a second embodiment, the lower pressure part of the Rankine cycle is completely replaced with an ammonia-water mixture power cycle at an optimal temperature point. This optimal point may vary between 100 C to 450 C, depending on the parameters of the main Rankine cycle. This embodiment is referred to as a Combined Steam-Ammonia Cycle.

In a third embodiment, the conventional bottoming cycle is modified by using an energy recovery turbine in place of throttle valve and replacing the extra-power-consuming high pressure pump by a small auxiliary pump. This will lead to further increase in efficiency of the combined cycle.

In a fourth embodiment, the conventional bottom cycle is modified by using a centrifugal absorber in place of condenser. This generates a lower pressure for the same ambient temperature of above mentioned combined cycle. In other words this bottoming cycle can work efficiently at high ambient temperatures. The size of the centrifugal absorber is lower than the conventional condenser.

In a fifth embodiment, the present combined cycle Rankine-Kalina cycle may be combined with any other high temperature power generation system, which can generate a flue gas with temperatures above 600 C (such as Solid Oxide Fuel Cell).

Although specific embodiments have been described hereinabove, it is recognized that one of ordinary skill in the art will understand the foregoing disclosure to include various modifications and alternative embodiments. For example, though the description focuses on a user interface having buttons for various functions, other forms of control are contemplated including rocker switches, toggles, pressure-sensitive areas on a programmable display, voice control, pointing devices, and those other mechanisms known in the art for interacting with electronic devices. It is intended that the following claims encompass such modifications and alternatives within their scope.

What is claimed is:

1. A boiling fluid reactor comprising a working fluid comprising water and ammonia, wherein ammonia vapor is produced from heat produced in a nuclear reactor core.

2. The boiling fluid reactor of claim 1, further comprising an ammonia turbine that is turned using the ammonia vapor.

3. A boiling water reactor comprising two working fluids, a first working fluid comprising water and a second working fluid comprising water and ammonia, wherein steam is produced from the first working fluid using heat produced in a nuclear reactor core and wherein ammonia vapor is produced from the second working fluid using heat from the first working fluid.

4. The boiling water reactor of claim 3, wherein the boiling water reactor is operated where the temperature of saturated water of the first working fluid is between 100 and 200 degrees Celsius.

5. The boiling water reactor of claim 3, wherein the boiling water reactor is operated where the temperature of saturated water of the first working fluid is between 200 and below 285 degrees Celsius.

6. The boiling water reactor of claim 3, wherein the boiling water reactor is operated where the temperature of saturated water of the first working fluid is around 285 degrees Celsius.

7. The boiling water reactor of claim 3, wherein the boiling water reactor is operated where the temperature of saturated water of the first working fluid is between above 285 and 300 degrees Celsius.

8. The boiling water reactor of claim 3, wherein the boiling water reactor is operated where the temperature of saturated water of the first working fluid is between 300 and 450 degrees Celsius.

9. The boiling water reactor of claim 3, further comprising a separator, wherein saturated liquid from the separator leaves the boiling water reactor and feeds an ammonia-water power plant.

10. The boiling water reactor of claim 3, wherein the boiling water reactor uses a conventional Kalina cycle, the boiling water reactor further comprising:
an ammonia turbine that produces power from the ammonia vapor.

11. The boiling water reactor of claim 3, wherein the boiling water reactor uses a modified Kalina cycle, the boiling water reactor further comprising:
an ammonia turbine that produces power from the ammonia vapor;
an energy recovery device that receives a higher-pressure, warm separator lean flow stream of the second working fluid and a cold feed stream of the second working fluid, wherein the energy recovery device transfers pressure from the higher-pressure, warm separator lean flow stream to a cold output stream formed from the cold feed stream, thereby forming a lower-pressure warm lean flow stream from the higher-pressure, warm separator lean flow stream; and
a heat exchanger that heats the cold output stream with a stream comprising the lower-pressure warm lean flow stream.

12. The boiling water reactor of claim 11, wherein the stream further comprises a rich output stream from the ammonia turbine.

13. The boiling water reactor of claim 3, wherein the boiling water reactor uses a conventional Mayahi cycle, the boiling water reactor further comprising:
an ammonia turbine that produces power from the ammonia vapor.

14. The boiling water reactor of claim 3, wherein the boiling water reactor uses a modified Mayahi cycle, the boiling water reactor further comprising:
an ammonia turbine that produces power from the ammonia vapor;
an energy recovery device that receives a higher-pressure, warm flow stream of the second working fluid and a cold feed stream of the second working fluid, wherein the energy recovery device transfers pressure from the higher-pressure, warm flow stream to a cold output stream formed from the cold feed stream, thereby forming a lower-pressure warm flow stream from the higher-pressure, warm flow stream; and
a heat exchanger that heats the cold output stream with a stream comprising a lower-pressure output stream from the ammonia turbine.

15. A heat engine system having a multi-component working fluid, the heat engine system comprising:
an energy recovery device that receives a higher-pressure, warm separator lean flow stream of the multi-component working fluid and a cold feed stream of the multi-component working fluid, wherein the energy recovery device transfers pressure from the higher-pressure, warm separator lean flow stream to a cold output stream formed from the cold feed stream, thereby forming a lower-pressure warm lean flow stream from the higher-pressure, warm separator lean flow stream; and
a heat exchanger that heats the cold output stream with a stream comprising the lower-pressure warm lean flow stream.

16. The heat engine system of claim 15, further comprising:
a separator that receives multiphase flow heated by a heat source, wherein the separator directs a mostly gaseous phase component of the multi-component working fluid towards a turbine and directs the higher-pressure, warm separator lean flow stream towards the energy recovery device; and
the turbine, wherein the turbine is turned by the mostly gaseous phase component of the multi-component working fluid, leaving a rich lower pressure output stream.

17. A heat engine system having a multi-component working fluid, the heat engine system comprising:
an energy recovery device that receives a higher-pressure, warm flow stream of the multi-component working fluid and a cold feed stream of the multi-component working fluid, wherein the energy recovery device transfers pressure from the higher-pressure, warm flow stream to a cold output stream formed from the cold feed stream, thereby forming a lower-pressure warm flow stream from the higher-pressure, warm flow stream; and
a heat exchanger that heats the cold output stream with a stream comprising a lower-pressure output stream from a turbine.

18. A method of operating a boiling fluid reactor comprising heating in a nuclear reactor core a working fluid comprising water and ammonia, wherein ammonia vapor is produced from the heating.

19. The method of operating boiling fluid reactor of claim 18, further comprising turning an ammonia turbine using the ammonia vapor.

20. A method of operating a boiling water reactor using two working fluids, a first working fluid comprising water and a second working fluid comprising water and ammonia, the method comprising: heating the first working fluid; producing steam from the first working fluid using heat produced in a nuclear reactor core, and producing ammonia vapor from the second working fluid from the heating of the first working fluid.

21. The method of operating the boiling water reactor of claim 20, the method further comprising separating the ammonia vapor from saturated liquid; and providing the saturated liquid as a heat source to an ammonia-water heat engine.

22. The method of operating the boiling water reactor of claim 20, wherein the boiling water reactor uses a conventional Kalina cycle, the method further comprising:
producing power from the ammonia vapor turning an ammonia turbine.

23. The method of operating the boiling water reactor of claim 20, wherein the boiling water reactor uses a conventional Mayahi cycle, the method further comprising:
producing power from the ammonia vapor turning an ammonia turbine.

24. A method of operating a heat engine system having a multi-component working fluid, the method comprising:
receiving a higher-pressure, warm separator lean flow stream of the multi-component working fluid;
receiving a cold feed stream of the multi-component working fluid;
transferring pressure from the higher-pressure, warm separator lean flow stream to a cold output stream formed from the cold feed stream, thereby forming a lower-pressure warm lean flow stream from the higher-pressure, warm separator lean flow stream; and
heating the cold output stream with a stream comprising the lower-pressure warm lean flow stream.

25. A method of operating a heat engine system having a multi-component working fluid, the method comprising:
receiving a higher-pressure, warm flow stream of the multi-component working fluid;
receiving a cold feed stream of the multi-component working fluid;
transferring pressure from the higher-pressure, warm flow stream to a cold output stream formed from the cold feed stream, thereby forming a lower-pressure warm flow stream from the higher-pressure, warm flow stream; and
heating the cold output stream with a stream comprising a lower-pressure output stream from a turbine.
